(19) United States
(12) Patent Application Publication
(10) Pub. No.: US 2003/0216200 A1
(43) Pub. Date: Nov. 20, 2003

(54) Continuously variable transmission

(76) Inventor: Mathias List, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/439,800

(22) Filed: May 16, 2003

(30) Foreign Application Priority Data
May 17, 2002 (DE) 102 22 001.8

(51) Int. Cl. F16H 59/00; F16H 63/00; F16H 55/56

(52) U.S. Cl. 474/28; 474/18; 474/46

(57) ABSTRACT

The invention concerns a continuously variable transmission especially for a motor vehicle. During a zero pressure condition of the transmission, the axially slidable conically tapered disk, on the input shaft, is subjected to a spring force, by a spring arrangement, so that the pressure on the V-belt is increased and the gear ratio of the transmission is lowered to an acceptable level to prevent inadvertent damage to the transmission.

### FIELD OF THE INVENTION

The invention concerns a continuously variable transmission, especially for a motor vehicle.

### BACKGROUND OF THE INVENTION

Such continuously variable transmission are generally known. Normally, continuously variable transmissions are equipped with a variator for setting the gear ratios. These variators comprise a primary pair of V-pulleys on an input shaft and a secondary pair of V-pulleys on an output shaft and a V-belt engaged between the primary and secondary pairs of pulleys. Each pair of V-pulleys comprises an axially fixed, conically tapered first disk and an axially slidable, conically tapered second disk. Conventionally, the input shaft of the variator is designated as the primary shaft which supports the primary V-pulley pair.

Analogously, the output shaft of the variator is normally called the secondary shaft and it supports the secondary V-pulley pair. The axial displacement of the primary disks or secondary disks and therewith the displacement of the gear ratio is accomplished by a pressure medium. Conventionally, the pressure medium is conducted through channels to one or more pressure chambers of the primary/secondary disks whereby, by means of a pressure fluid pump, the necessary oil pressure is made available.

The pressure supply for the entire transmission is, in most cases, made possible by one hydraulic fluid pump which, by connection to the input shaft, has a corresponding rotational speed. The demanded volume of oil depends directly on this rotational speed. If, the input rotational speed declines to zero, then the transmission is no longer supplied with oil, which occurrence is known as a zero pressure condition. In this situation, normally the transmission assumes its maximum gear ratio. As this occurs, the primary disks spread themselves from one another as widely as possible and the V-belt lies, primary-sided, on the smallest possible frictional surface. Analogous to this, the frictional surface of the V-belt on the output shaft, which is provided by the secondary disks, is at its maximum. If, in this condition, the motor vehicle is to be towed, serious problems can result, such as:

The drive wheels of the vehicle introduce a moment in the transmission, which transmission finds itself in the described zero-pressure condition.

This moment is transmitted through the output shaft and the V-belt to the input shaft. Since, in the zero-pressure condition a minimum radius is presented on the drive side, and correspondingly a maximum radius on the output side, then the input shaft is caused to accelerate very suddenly. However, since the transmission is in the zero-pressure condition and the contact force on the primary sided V-disks is at a minimum, this sudden acceleration can lead to a slipping of the V-belt on the primary disk, with resulting major damage thereto.

Furthermore, due to this slippage, a clutch, which is connected to the input shaft, is also steeply accelerated even when the motor of the vehicle is motionless.

If a certain threshold is then overstepped, an undesirable lock-up of the clutch can be caused by the occurring rotational pressure in the clutch assembly. The towing moment can then lead to an overheating of the clutch with contingent damage.

Thus, the purpose of the invention is to develop a continuously variable transmission in which the above described problems have been solved.

### SUMMARY OF THE INVENTION

In accord with the invention, the purpose is achieved, in that the sliding disk on the primary side is provided with a diaphragm spring, and is thus loaded with a spring force. With this provision, the stationary disk, in the zero-pressure condition of the transmission, is axially pushed in the direction of the stationary disk. In this way the contact pressure of the V-pulleys on the V-belt is increased and a slippage of the V-belt in the zero-pressure condition is avoided.

In addition to this, the separating distance between the primary disks is reduced in the axial direction, whereby the friction contact radius of the V-belt on the primary disks is increased and the gear ratio is reduced. The diaphragm spring is advantageously so held by a detent, that the spring force only acts within a defined gear ratio range on the slidable disk. Thereby, the degree of the power stroke, as well as their number is diminished. This situation acts positively on the life of the spring apparatus.

The force of the diaphragm spring must also not permanently operate in an overload situation, but remain only in the preferred gear ratio range.

An advantageous embodiment is realized by at least one diaphragm spring which is installed outside of a first pressure space of the pressure apparatus of the slidable disk of the input shaft. This diaphragm spring, supported by a hub affixed to the input shaft, biases or stresses the axially slidable disk. Thereby, in the zero-pressure condition of the transmission, the slidable disk is biased away from the hub in the direction toward the stationary disk.

### BRIEF DESCRIPTION OF THE DRAWINGS

The invention will now be described, by way of example, with reference to the accompanying drawings in which:

FIG. 1 is a diagrammatic cross-sectional view of the invented parts of a continuously variable transmission,

FIG. 2 is a diagrammatic cross-sectional view of a first invented position of a diaphragm spring, and

FIG. 3 is a diagrammatic cross-sectional view of a second invented position of a diaphragm spring.

### DETAILED DESCRIPTION OF THE INVENTION

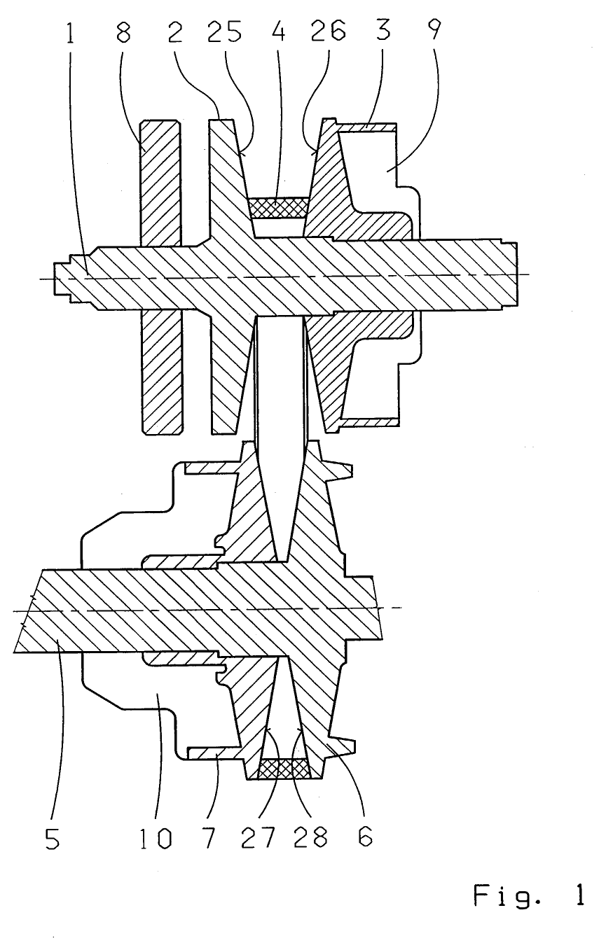

FIG. 1 is a view showing the essential parts of a continuously variable transmission. A first input shaft 1 carries a primary pair of disks 2, 3, which are designed with tapered friction surfaces 25, 26. In FIG. 1, one of the primary disks, which is firmly attached to the input shaft 1, is designated as a fixed disk 2 while the other primary disk 3 is axially slidable or movable along the input shaft 1. A V-belt 4 is located between the primary pair of disks 2, 3 and the V-belt 4, during driving operation, transmits torque from the input shaft 1 and the primary pair of disks 2, 3 to the output shaft 5. The secondary pair of disks 6, 7, likewise designed with tapered friction surfaces 27 and 28, are supported on the output shaft 5. One of the secondary pair of disks, which is firmly attached to the output shaft 5, is designated as a fixed disk 6 while the other secondary disk 7 is axially slidable or movable along the output shaft 5. The V-belt 4 is located between the secondary pair of disks 6, 7 and the V-belt 4, during driving operation, transmits torque from the primary pair of disks 2, 3 to the secondary pair of disks 6, 7 and the output shaft 5. A first clutch 8 is solidly affixed to the input shaft 1. In addition to the primary pair of disks 2, 3 and secondary pair of disks 6, 7, primary and secondary pressure apparatuses 9, 10 (only diagrammatically shown in FIG. 1) respectively facilitate pressurization and movement of the axially slidable or movable disk 3, 7 in a conventional manner. As such pressurization feature is well known in the art, a further discussion concerning the same is not provided.

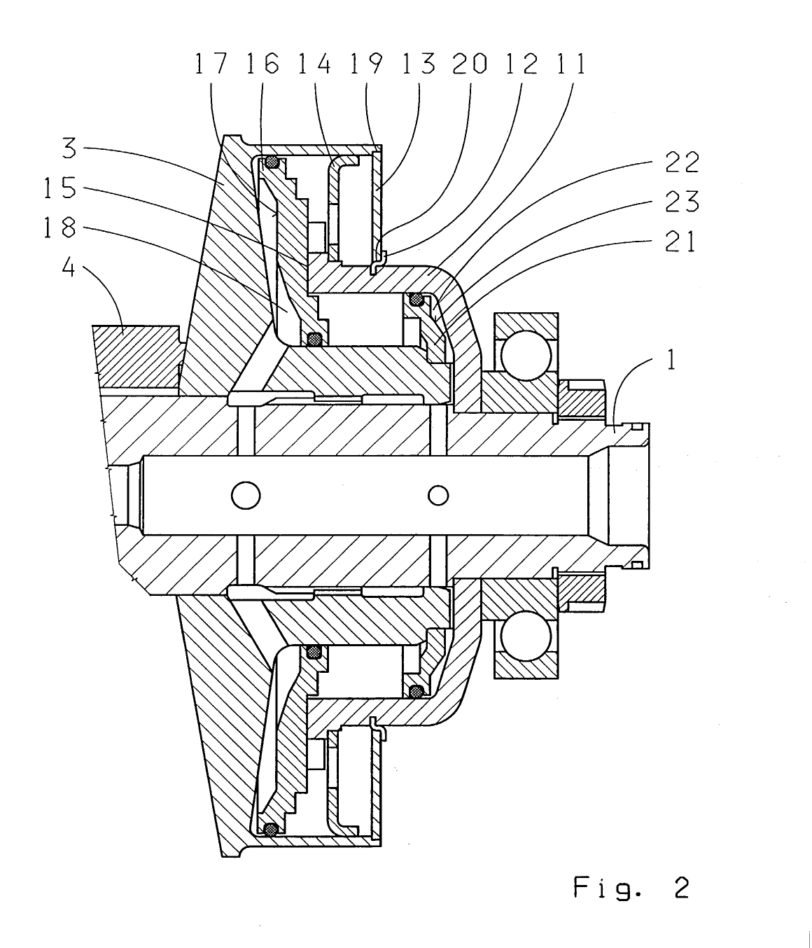

FIG. 2 shows a detailed view of the invented diaphragm spring arrangement. The slidable primary disk 3 is supported on the input shaft 1. Additionally, a hub 11 is affixed to and supported by the input shaft 1. A first stop or detent 12 is supported on an exterior surface of the hub 11 and this detent 12 acts as a stop for a diaphragm spring 13 to prevent or limit axial movement of the diaphragm spring 13 along the exterior surface of the hub 11 in a direction away from the fixed disk 2 supported by the input shaft 1. An inner radial edge 20 of the diaphragm spring 13 abuts against and is centered by the first detent 12. An L-shaped second detent 14 is also supported on the hub 1 and this second detent 14 extends radially outward away from the hub 11. The L-shaped second detent 14, in an inactive condition of the diaphragm spring 13, engages with an outer edge 19 of the diaphragm spring 13 to maintain the diaphragm spring 13 in a desired relaxed position so that the outer edge 19 of the diaphragm spring 13 is located to engage with an annular sleeve (not number) of the slidable primary disk 3 as the primary pressure apparatus 9 is reduced toward and approaches a zero pressure condition. As the pressure in the primary pressure apparatus 9 is reduced and approaches the zero pressure condition, the slidable primary disk 3 moves toward the hub 11 (see FIG. 2) and once the slidable primary disk 3 travels a sufficient distance, a leading annular surface of the annular sleeve of the slidable primary disk 3 engages with the annular outer edge 19 of the diaphragm spring 13. The diaphragm spring 13, due to this engagement, resists further movement of the slidable primary disk 3 away from the fixed disk 2. The diaphragm spring 13 thus maintains sufficient pressure on the V-belt 4 and thus prevents the slidable primary disk 3 from moving sufficiently away from the fixed disk 2 so that slippage of the V-belt 4 can occur.

A first pressure piston 16 is located within an open end 15 of the hub 11. This first pressure piston 16, together with its piston surface 17 and the slidable disk 3, forms a first pressure chamber 18 for inducing axially movement of the slidable disk 3 in a direction toward the fixed disk 2. A second pressure piston 21 is accommodated on the primary slidable disk 3 and the second pressure piston 21 also acts upon the sliding primary disk 3 inducing axially movement of the slidable disk 3 in a direction toward the fixed disk 2. The second pressure piston 21, together with the shaft hub 11, the input shaft 1 and the piston surface 23, form a second pressure chamber 22.

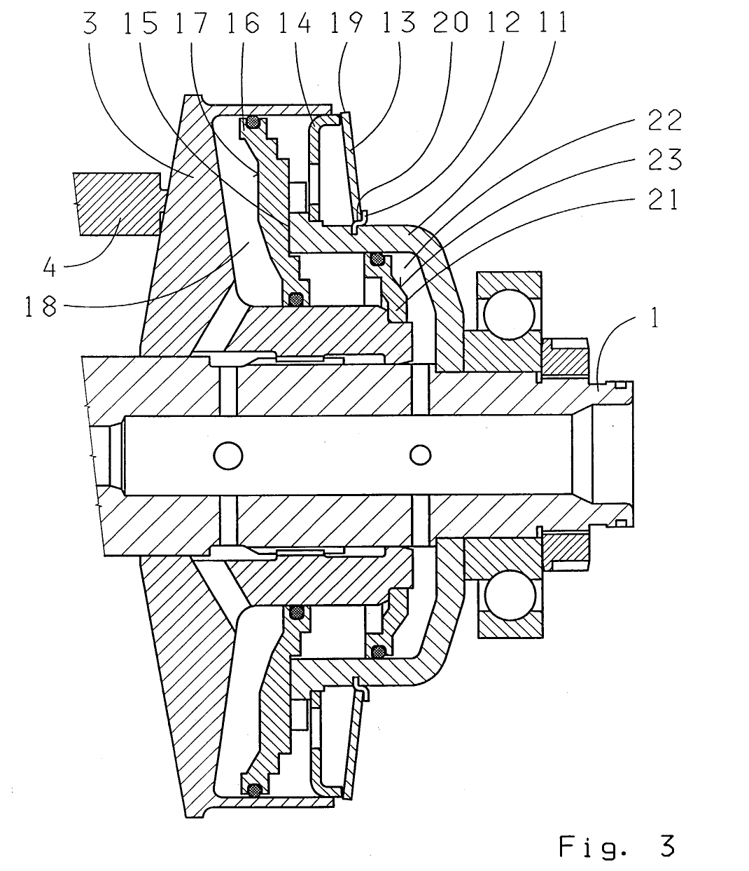

FIG. 3 shows a construction corresponding to FIG. 2, wherein the diaphragm spring 13 abuts against the second detent 14 and thus is prevent from and does not exert any force upon or against the slidable primary disk 3. The slidable primary disk 3, in this Figure, is forced by the primary pressure apparatus 9 as far as possible toward the axially immovable or fixed primary disk 2. At the same time, the frictional radius of the V-belt 4, between the primary disks 2 and 3, is correspondingly at a maximum. This position shown in FIG. 3 corresponds to an “overdrive” condition of the transmission. As the force supplied by the two pressure pistons 16, 21 is sufficient to cause and maintain the “overdrive” condition of the transmission, the biasing force of the diaphragm spring 13 is not required and thus the diaphragm spring 13 merely engages with the second detent 14.

When a ratio of the continuously variable transmission is in a range of about iV>1, the diaphragm spring (13) engages with and exerts a spring force on the sliding disk (3) and, when the ratio of the continuously variable transmission is in the range of about iV≦1, the diaphragm spring (13) engages a detent (14) and is prevent from exerting a force on the sliding disk (3).

Reference Numbers and Corresponding Components

1 input shaft to transmission

2 axially fixed, tapered disk of V-pulley on input shaft 1

3 axially slidable, tapered disk of V-pulley on output shaft 1

4 V-belt between primary V-pulley and secondary V-pulley

5 output shaft from transmission

6 axially fixed, tapered disk of V-pulley on output shaft 5

7 axially slidable, tapered disk of V-pulley on output shaft 5

8 clutch

9 pressure apparatus (primary)

10 pressure apparatus (secondary)

11 hub

12 first detent, abutment for inner edge of diaphragm spring 13

13 diaphragm spring

14 second detent, contacts outer edge of diaphragm spring 13

15 open end of the hub

16 a first pressure piston

17 surface of first pressure piston

18 a first pressure chamber

19 the outer edge of the diaphragm spring

20 the inner edge of the diaphragm spring

21 a second pressure piston

22 a second pressure chamber

23 surface of the second pressure piston

Claimed is:

1. A continuously variable transmission, especially for motor vehicles, wherein a V-belt (4) runs between two pairs of conically tapered disks (2, 3, 6, 7), which are mounted on a input shaft (1) and an output shaft (5) and of which disks, respectively, one is designed as a fixed disk (2, 6) and the other as an axially sliding disk (3, 7) and which possess conically tapered frictional surfaces (25 to 28) and for axial displacement the sliding disks (3, 7) are respectively equipped with a pressure apparatus (9, 10), therein characterized in that the pressure apparatus (9), by means of at least one diaphragm spring (13) in a condition of no pressure of the transmission exerts a safety oriented basic pressure on the slidable disk (3) of the input shaft (1) whereby the diaphragm spring (13) is placed outside of a first pressure chamber (19) and in an engaged spring condition, stresses the slidable disk (3) by abutting itself against an affixed shaft hub (11).

2. The continuously variable transmission according to claim 1, wherein the diaphragm spring (13) is held and centered on its inner edge (20) by a detent (12) by a shaft affixed hub (11).

3. The continuously variable transmission according to claim 1, wherein the diaphragm spring (13) in its active condition exerts, by its outer edge (19), an axial force in the direction of the fixed disk (2) against the sliding disk (3) of the input shaft (1).

4. The continuously variable transmission according to claim 1, wherein the diaphragm spring (13) in its active condition exerts, by its inner radial edge (20), an axial force against the shaft affixed hub (11) counter to the direction to the fixed disc 2.

5. The continuously variable transmission according to claim 1, wherein the diaphragm spring (13), in the relaxed position, exerts by its outer edge (19) an axial force against a detent (14) affixed to the hub (11) in the direction of the fixed disk (2).

6. The continuously variable transmission according to claim 1, wherein the diaphragm spring (13) in the range of iV>1 exerts a spring force against the sliding disk (3).

7. The continuously variable transmission according to claim 1, wherein the diaphragm spring (13) in the range of iV>1 exerts a spring force against the sliding disk (3) and in the range of iV≦1, the diaphragm spring (13) is pressed against a detent (14).

8. The continuously variable transmission according to claim 1, wherein the pressure apparatus (9) of the sliding disk (3) has at least a second pressure chamber (22).

9. The continuously variable transmission according to claim 1, wherein the second pressure chamber (22) is confined within a second pressure piston (21), the shaft affixed hub (16) and the input shaft (1).

10. The continuously variable transmission for a motor vehicle in which a V-belt (4) runs between a primary pair of conically tapered disks (2, 3) mounted on an input shaft (1) and a secondary pair of conically tapered disks (6, 7) mounted on an output shaft (5), one disk of both the primary and secondary pairs of conically tapered disks is a fixed disk (2, 6) and the other disk of the primary and secondary pairs of conically tapered disks is an axially sliding disk (3, 7), the primary pair of conically tapered disks (2, 3) is equipped with a primary pressure apparatus (9) for facilitating axial displacement the primary axially sliding disk (3) and the secondary pair of conically tapered disks (6, 7) is equipped with a secondary pressure apparatus (10) for facilitating axial displacement the secondary axially sliding disk (7), and all of the conically tapered disks (2, 3, 6, 7) having conically tapered frictional surfaces (25, 26, 27, 28);
wherein the primary pressure apparatus (9) includes at least one diaphragm spring (13) for exerting pressure on the sliding disk (3) of the input shaft (1), as the continuously variable transmission approaches a zero pressure condition, to prevent slippage of the V-belt (4) relative to the primary and secondary pairs of conically tapered disks (2, 3, 6, 7), and the diaphragm spring (13) is located outside of a first pressure chamber (18) and, in an active condition of the diaphragm spring (13), biases the sliding disk (3) on the input shaft (1) toward, the fixed disk (2, 6) the input shaft (1).

11. The continuously variable transmission according to claim 10, wherein the diaphragm spring (13) is supported by a hub (11) which is carried by the input shaft (1) and an inner edge (20) of the diaphragm spring (13) mates with a detent (12) supported by the hub (11) to locate the diaphragm spring (13) on the hub (11) and limit axial movement of the diaphragm spring (13).

12. The continuously variable transmission according to claim 10, wherein an outer edge (19) of the diaphragm spring (13), in an active condition of the diaphragm spring (13), exerts an axial force on the sliding disk (3) of the input shaft (1) to bias the sliding disk (3) toward the fixed disk (2).

13. The continuously variable transmission according to claim 10, wherein an inner radial edge (20) of the diaphragm spring (13), in an active condition of the diaphragm spring (13), exerts an axial force on a hub (11) which is carried by the input shaft (1) and the exerted force on the hub (11 ) is in a direction away from the fixed disc (2) of the input shaft (1).

14. The continuously variable transmission according to claim 10, wherein an outer edge (19) of the diaphragm spring (13), in an inactive condition of the diaphragm spring (13), exerts an axial force on a detent (14), supported by a hub (11) which is carried by the input shaft (1), in a direction toward the fixed disk (2).

15. The continuously variable transmission according to claim 10, wherein, when a ratio of the continuously variable transmission (iV) is ≧1, the diaphragm spring (13) is active to bias the sliding disk (3) toward the fixed disk (2, 6) on the input shaft (1).

16. The continuously variable transmission according to claim 10, wherein, when a ratio of the continuously variable transmission is in a range of about iV>1, the diaphragm spring (13) engages with and exerts a spring force on the sliding disk (3) and, when the ratio of the continuously variable transmission is in the range of about iV≦1, the diaphragm spring (13) engages a detent (14) and is prevent from exerting a force on the sliding disk (3).

17. The continuously variable transmission according to claim 10, wherein the primary pressure apparatus (9) of the sliding disk (3) includes at least a second pressure chamber (22).

18. The continuously variable transmission according to claim 17, wherein the second pressure chamber (22) is defined by the input shaft (1), a second pressure piston (21), the hub (11) and the sliding disk (3) on the input shaft (1).

19. A continuously variable transmission for a motor vehicle in which a V-belt (4) runs between a primary pair of conically tapered disks (2, 3) mounted on an input shaft (1) and a secondary pair of conically tapered disks (6, 7) mounted on an output shaft (5), one disk of both the primary and secondary pairs of conically tapered disks is a fixed disk (2, 6) and the other disk of the primary and secondary pairs of conically tapered disks is an axially sliding disk (3, 7), the primary pair of conically tapered disks (2, 3) is equipped with a primary pressure apparatus (9) for facilitating axial displacement the primary axially sliding disk (3) and the secondary pair of conically tapered disks (6, 7) is equipped with a secondary pressure apparatus (10) for facilitating axial displacement the secondary axially sliding disk (7), and all of the conically tapered disks (2, 3, 6, 7) having conically tapered frictional surfaces (25, 26, 27, 28);
wherein the primary pressure apparatus (9) includes at least one diaphragm spring (13) for exerting pressure on the sliding disk (3) of the input shaft (1), as the continuously variable transmission approaches a zero pressure condition, to prevent slippage of the V-belt (4) relative to the primary and secondary pairs of conically tapered disks (2, 3, 6, 7).
